(19) United States
(12) Patent Application Publication
(10) Pub. No.: US 2026/0217243 A1
(43) Pub. Date: Jul. 30, 2026

(54) METHOD FOR CONTROLLING THE TRAJECTORY OF A VEHICLE ENABLING OBSTACLE AVOIDANCE

(71) Applicant: AMPERE S.A.S., Boulogne Billancourt (FR)

(72) Inventors: Dimitrios KAPSALIS, Guyancourt cedex (FR); John-Jairo MARTINEZ, Guyancourt cedex (FR); Vicente MILANES, Guyancourt cedex (FR); Olivier SENAME, Saint Martin d'Hères (FR)

(73) Assignee: AMPERE S.A.S., Boulogne Billancourt (FR)

(21) Appl. No.: 19/141,852

(22) PCT Filed: Dec. 5, 2023
(86) PCT No.: PCT/EP2023/084386

§ 371 Date: Jun. 20, 2025

(30) Foreign Application Priority Data
Dec. 21, 2022 (FR) FR2214150

(51) Int. Cl. B60W 30/09; B60W 30/095; B60W 30/14

(52) U.S. Cl. CPC B60W 30/09; B60W 30/0953; B60W 30/0956; B60W 30/143; B60W 2520/14; B60W 2554/802; B60W 2710/207; B60W 2720/106

(57) ABSTRACT

A method controls the trajectory of a vehicle when approaching an obstacle. The method includes controlling a steering angle of the wheels implementing a calculation of a yaw rate setpoint of the vehicle and a control loop of the steering angle of the wheels as a function of the calculated yaw rate setpoint, controlling the steering angle of the wheels using a longitudinal speed of the vehicle, and controlling a speed of the vehicle. The longitudinal speed of the vehicle is a set longitudinal speed determined during the step of controlling the speed of the vehicle.

The present invention relates to the field of the motor-vehicle industry, and more precisely relates to a method for controlling the path of an autonomous vehicle or a vehicle equipped with an advanced driver-assistance system.

These vehicles are equipped with sensors allowing their surroundings to be apprehended, and actuators allowing the transmission and steering of the vehicle to be controlled, without intervention by the driver, the actuators themselves being controlled by one or more computers that are generally embedded in the vehicle. Such a vehicle therefore manages itself the path of the vehicle, at least in certain driving contexts.

Such a vehicle must deal with scenarios that are generally complex. In order for a computer of the vehicle to be able to make and execute an optimal decision as regards the path to be followed, for example in terms of steering-wheel angle or vehicle speed, it is necessary for a number of software modules to interact and the information delivered by these modules to be fused in real time.

One of the recurring complex problems that such a vehicle must solve is avoidance of obstacles at high speeds. Specifically, this problem requires interaction between a lateral control system of the vehicle, managing the steering angle of the wheels of the vehicle, and a longitudinal control system of the vehicle, managing the speed of the vehicle. Integrating the data of these systems with a view to solving this problem results in a non-linear equation that is difficult to solve in real time to regulate both the speed of the vehicle and the steering angle of the wheels of the vehicle.

Existing control solutions for managing obstacle-avoidance maneuvers are mainly based solely on regulation of the steering of the vehicle, which, depending on a measured longitudinal speed of the vehicle, dynamically modifies a yaw rate of the vehicle toward a new reference path generated by the vehicle computer.

Because the generation of a yaw-rate setpoint is intimately related to the measured longitudinal speed of the vehicle, at high speed during an obstacle-avoidance maneuver the vehicle will reach its physical limitations and will be incapable of turning as fast as requested and of achieving the yaw-rate setpoint. This may cause oscillations or even instability of the vehicle even if it finally manages to avoid the obstacle and reach a new reference path.

These solutions do not take into account the longitudinal evolution of the vehicle in their computation of yaw rate, nor the physical limitations of the braking and steering systems of the vehicle, this potentially preventing the vehicle from satisfactorily performing the avoidance maneuver.

The invention aims to at least partly remedy the drawbacks of the prior art by providing a method for controlling the path of a vehicle approaching an obstacle, in which longitudinal-speed and yaw-rate setpoints of the vehicle are optimized so that the physical limitations of a steering system of the vehicle can be respected at high speeds, thus allowing the vehicle to avoid the obstacle via a rapid maneuver without creating instability.

To this end, the invention provides a method for controlling the path of a vehicle approaching an obstacle, comprising a step of controlling a steering angle of the wheels implementing a computation of a yaw-rate setpoint of the vehicle and a loop for controlling the steering angle of the wheels depending on the computed yaw-rate setpoint, the step of controlling the steering angle of the wheels using a longitudinal speed of the vehicle, the control method being characterized in that it further comprises a step of controlling a speed of the vehicle, and in that said longitudinal speed of the vehicle is a setpoint longitudinal speed determined in the step of controlling the speed of the vehicle.

By virtue of the invention, a complex obstacle-avoidance problem is answered simply by virtue of decoupling of the step of controlling the speed of the vehicle on the one hand and the step of controlling the steering angle of the wheels of the vehicle on the other hand, the step of controlling the steering angle of the wheels using only one exogenous parameter generated in the step of controlling the speed of the vehicle. Specifically, these two steps are executed in parallel, and the step of controlling the steering angle of the wheels of the vehicle has no influence on the step of controlling the speed of the vehicle. Conversely, only the setpoint longitudinal speed of the vehicle influences the step of controlling the steering angle of the wheels of the vehicle. In the present patent application, the longitudinal direction of the vehicle is oriented parallel to the length of the vehicle. Through use of this decoupling, each step may take into account limitations specific to the braking system or steering system of the vehicle.

According to one advantageous feature of the path-control method according to the invention, the step of controlling the speed of the vehicle comprises a substep of optimizing an objective function taking into account a distance computed depending, on the one hand, on a measured distance between the vehicle and the obstacle and, on the other hand, on a yaw angle of the vehicle, the optimizing substep being able to provide a setpoint longitudinal acceleration of the vehicle, integration of which provides said setpoint longitudinal speed. By virtue of this feature, information delivered by the sensors of the vehicle is added to the control loop. Specifically, the setpoint longitudinal speed takes this information into account, and requires the vehicle to slow down when approaching the obstacle, this allowing the yaw rate to be adapted to a setpoint longitudinal speed lower than in the prior art, and an obstacle to be avoided without oscillations. The computed distance is dependent on the distance measured at least for a certain time before the obstacle is bypassed. The setpoint longitudinal acceleration is here a value that may be positive or negative, i.e. it may be a longitudinal acceleration or deceleration setpoint.

In one embodiment of the invention, the computed distance is dependent on a minimum safety distance between the vehicle and the obstacle to be bypassed. Thus, the obstacle is avoided with a configurable safety margin.

Advantageously, the computed distance increases as a function of the yaw angle of the vehicle at least until the yaw angle allows the obstacle to be bypassed. Thus, as the vehicle gets closer to its objective of avoiding the obstacle, braking is decreased, this allowing the vehicle to change direction to follow a new path without excessive deceleration.

In one embodiment of the invention, the optimizing substep meets a constraint according to which a distance travelled by the vehicle during a predetermined number of computation increments must be less than said computed distance. This embodiment of the optimizing substep allows a configurable adaptation of the braking distance in real time.

According to one advantageous feature of the path-control method according to the invention, as soon as the yaw angle allows the obstacle to be bypassed, the computed distance is updated so that it no longer depends on the measured distance between the vehicle and the obstacle, in accordance with a predefined choice of driving mode. Thus, the deceleration of the vehicle once it has been steered so as to avoid the obstacle is configurable depending on a choice of driving style, as for example selected by a user of the vehicle. In particular, the user may choose the speed of execution of the complete obstacle-avoidance maneuver by selecting a fast or sporty mode or a mode delivering an experience that feels safer and smoother.

For example, as soon as the yaw angle allows the obstacle to be bypassed, the computed distance is updated so as to no longer constrain the objective function, or to constrain it depending on another obstacle on the path of the vehicle, instead of said obstacle to be bypassed. As a variant, the constraint regarding the computed distance is removed in the substep of optimizing the objective function. This removal of the dependence of the setpoint longitudinal speed on the computed distance allows the vehicle to regain speed as soon as it is no longer being steered toward the obstacle, and to reach its new path very quickly.

Alternatively, the environment of the vehicle being divided orthogonally to an initial path of the vehicle, into a first zone not containing the obstacle and lying between the vehicle and a first end of the obstacle, and a second zone containing the obstacle and lying between the first end of the obstacle and a second end of the obstacle, as long as the vehicle is in the first zone, as soon as the yaw angle allows the obstacle to be bypassed, the computed distance is updated such that it no longer depends on anything but the yaw angle and a distance between the vehicle and a target path of the vehicle. In this alternative, the vehicle truly regains speed only when the vehicle begins to pass the obstacle, this making its maneuver smoother than in the previous example.

In yet another alternative, the environment of the vehicle being divided orthogonally to an initial path of the vehicle, into a first zone not containing the obstacle and lying between the vehicle and a first end of the obstacle, and a second zone containing the obstacle and lying between the first end of the obstacle and a second end of the obstacle, as long as the vehicle is in the first or second zone, as soon as the yaw angle allows the obstacle to be bypassed, the computed distance is updated such that it no longer depends on anything but the yaw angle and a distance between the vehicle and a target path of the vehicle. In this other alternative, the vehicle truly regains speed only when the vehicle has passed the obstacle, this making its maneuver even more comfortable and smoother than in the previous example.

The invention also relates to a computer program comprising program code instructions for executing the steps of the control method according to the invention, when said program is executed on one or more computers of a vehicle. The computer program according to the invention has advantages analogous to those of the control method according to the invention.

Other features and advantages of the invention will become more apparent from the following description, on the one hand, and from a plurality of non-limiting examples of embodiment that are given by way of indication with reference to the appended schematic drawings, on the other hand, in which drawings:

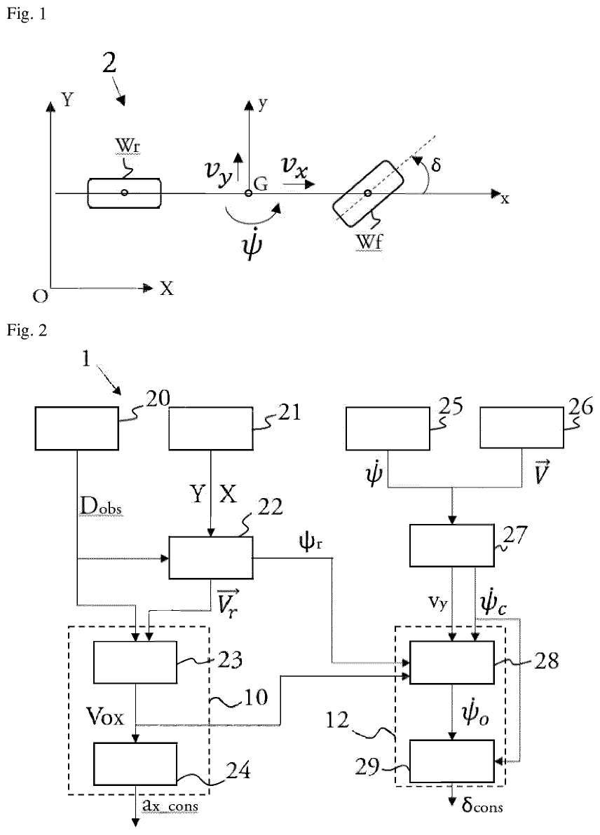

FIG. 1 schematically illustrates frames for positioning a vehicle implementing a control method according to the invention, these frames being used by this control method according to the invention, in one embodiment of the invention,

FIG. 2 illustrates means and steps used or implemented by the control method according to the invention, in this embodiment of the invention,

FIG. 3 illustrates an environment of the vehicle as modelled by the control method of FIG. 2,

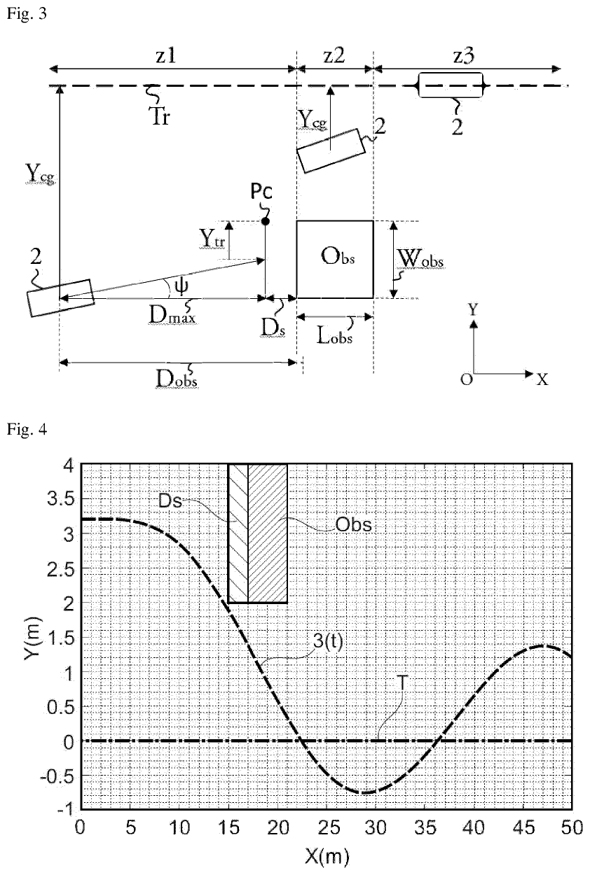

FIG. 4 shows the path taken by a vehicle not implementing the control method according to the invention, during an obstacle-avoidance maneuver,

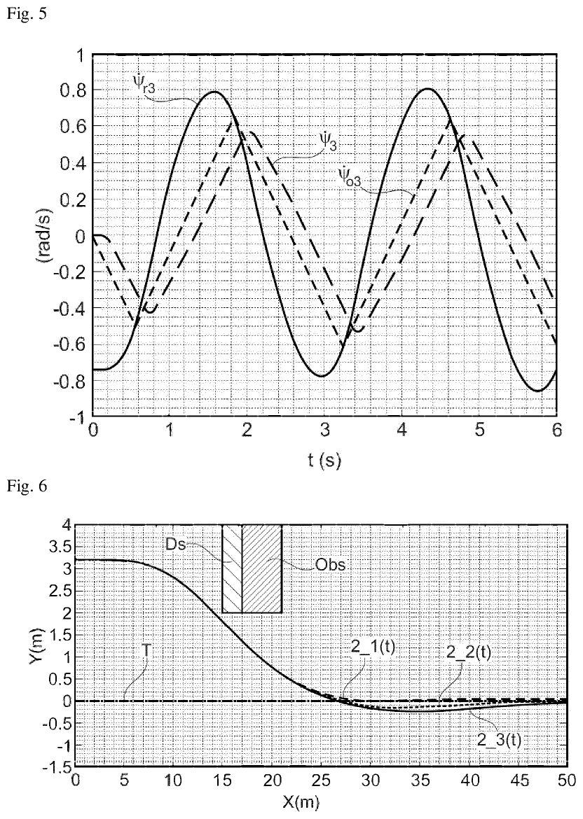

FIG. 5 shows yaw rates of the vehicle of FIG. 4 during this obstacle-avoidance maneuver,

FIG. 6 shows paths taken by the vehicle of FIG. 1 implementing the control method of FIG. 2 during an obstacle-avoidance maneuver,

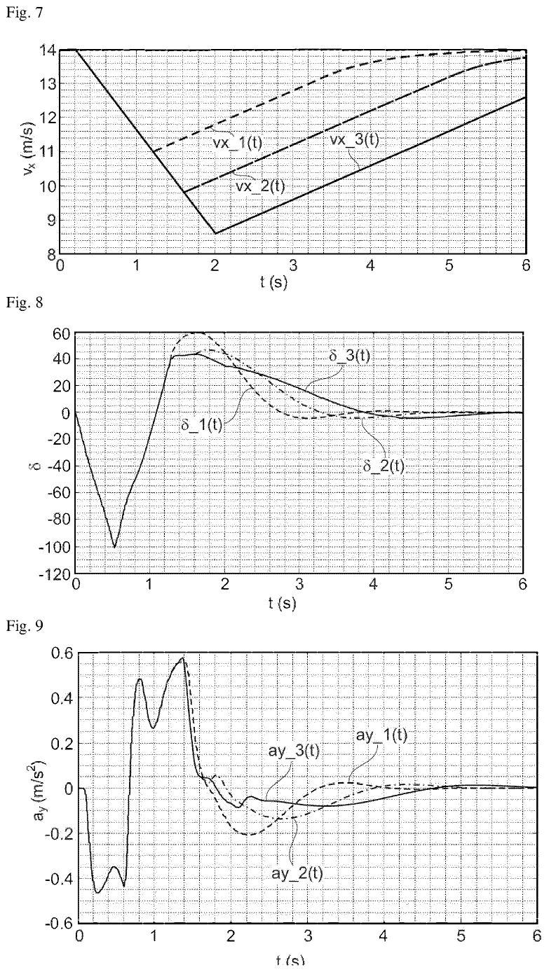

FIG. 7 shows longitudinal speeds of the vehicle of FIG. 1 on the paths taken thereby as shown in FIG. 6,

FIG. 8 shows steering-wheel angles of the vehicle of FIG. 1 on the paths taken thereby as shown in FIG. 6, and

FIG. 9 shows lateral accelerations of the vehicle of FIG. 1 on the paths taken thereby as shown in FIG. 6.

In one embodiment of the invention, a vehicle 2 (represented in FIG. 1 by a so-called “bicycle” model) implements a path-control method 1 according to the invention (see FIG. 2), and has a center of gravity G. Its position is measured in an orthonormal frame (O, X, Y) that is fixed with respect to the vehicle 2, and in which a yaw rate \dot{ψ} of the vehicle is measured. The axis (OX) is parallel to an initial path of the vehicle, on which an obstacle Obs (see FIG. 3) is found.

In the so-called “bicycle” model, the rear wheels of the vehicle 2 are merged into a single wheel Wr and the front wheels of the vehicle 2 into a single wheel Wf. An orthonormal frame (G,x,y) tied to the vehicle 2 comprises a longitudinal axis (Gx) that passes through the center of gravity G of the vehicle 2, and through the center of the merged wheels Wr, Wf, and that is oriented toward the front of the vehicle 2. This longitudinal axis (Gx) is called the longitudinal axis of the vehicle 2. The orthonormal frame (G,x,y) comprises a lateral axis (Gy) passing through the center of gravity G of the vehicle, parallel to the floor of the vehicle and orthogonal to the longitudinal axis (Gx) of the vehicle 2. This lateral axis (Gy) is here directed toward the left-hand side of the vehicle 2 and is called the lateral axis of the vehicle 2.

In the orthonormal frame (G,x,y) tied to the vehicle 2, a measured speed \vec{V} (with respect to the fixed orthonormal frame (O,X,Y)) of the vehicle 2 is broken down along the longitudinal axis (Gx) into a longitudinal speed νₓ, and along the lateral axis (Gy) of the vehicle 2 into a lateral speed ν_{y}. The front wheel Wf makes a steering angle δ to the longitudinal axis (Gx) of the vehicle 2. This steering angle δ is a steering angle of the wheels of the vehicle 2, representative of the direction taken thereby at a given time.

As shown in FIG. 2, the vehicle 2 comprises means 20 for perceiving the immediate environment of the vehicle 2, these perceiving means 20 comprising one or more sensors such as radars, LiDARs (LiDAR being the acronym of Light Detection And Ranging) or cameras. The perceiving means 20 deduce from these sensors a measured distance Dobs between the vehicle 2 and the obstacle Obs located on the initial path of the vehicle 2.

The vehicle 2 in addition comprises a positioning means 21 such as a GPS module (GPS being the acronym of Global Positioning System) capable of providing a position (X,Y) of the vehicle 2 in the fixed orthonormal frame (O,X,Y).

The vehicle 2 also comprises a gyroscope 25 supplying the measured yaw rate \dot{ψ} of the vehicle 2, and a speed sensor 26 supplying the measured speed \vec{V} of the vehicle 2.

In this embodiment of the invention, the control method 1 is implemented in a computer of the vehicle 2, which receives, for example via a central CAN bus of the vehicle 2 (CAN being the acronym of Controller Area Network), the measured distance Dobs to the obstacle Obs, the position (X,Y) of the vehicle 2 in the fixed orthonormal frame (O,X,Y), the measured yaw rate \dot{ψ} and the measured speed \vec{V} of the vehicle 2, these data being updated in real time by the various means and sensors of the vehicle 2.

The computer of the vehicle 2 comprises a navigating module 22 that generates, based on the position (X, Y) of the vehicle 2, and on the measured distance Dobs to the obstacle Obs, a new path Tr (see FIG. 3) to be followed by the vehicle 2, with a reference speed \vec{V}ᵣ and a reference yaw angle ψr that follows the curve of this new path Tr.

The computer of the vehicle 2 also comprises a module 27 for estimating the lateral state of the vehicle 2. This estimating module 27 estimates a lateral speed ν_{y} of the vehicle 2 in the orthonormal frame (G,x,y) of the vehicle 2, and uses a model to provide a corrected yaw rate \dot{ψ}c in particular based on the measured yaw rate \dot{ψ}.

The computer of the vehicle 2 implements a step 10 of controlling the speed of the vehicle 2, this step 10 using a longitudinal planner 23, which optimizes the reference speed \vec{V}ᵣ in particular depending on the physical characteristics of the braking, propulsion and transmission systems of the vehicle 2, and on the measured distance Dobs to the obstacle Obs. The longitudinal planner 23 delivers as output a setpoint longitudinal speed Vox. How this setpoint longitudinal speed is obtained will be described in detail below with reference to FIG. 3.

The step 10 of controlling the speed of the vehicle also uses a longitudinal controller 24 that applies a setpoint acceleration or deceleration ax_cons to actuators of the vehicle 2 in order to make it achieve the setpoint longitudinal speed Vox.

In parallel with this step 10 of controlling the speed of the vehicle 2, the computer of the vehicle 2 implements a step 12 of controlling the yaw rate of the vehicle 2, using a lateral planner 28 the operation of which will be described in detail below with reference to FIG. 3. The lateral planner 28 receives as input the lateral speed ν_{y} of the vehicle 2 estimated by the estimating module 27, the corrected yaw rate \dot{ψ}c provided by the estimating module 27, the reference yaw angle ψr provided by the navigating module 22, and the setpoint longitudinal speed Vox delivered by the longitudinal planner 23. The lateral planner 28 uses these inputs to provide a yaw-rate setpoint \dot{ψ}o. This setpoint takes into account the physical limitations of the steering system of the vehicle 2.

Step 12 of controlling the yaw rate of the vehicle 2 also uses a lateral controller 29 that implements, depending on the yaw-rate setpoint \dot{ψ}o, a loop for controlling a setpoint δcons of the steering angle of the wheels, which setpoint is sent to actuators of the vehicle 2 in order to make it achieve this yaw-rate setpoint \dot{ψ}o.

In step 10 of controlling the speed of the vehicle 2, the longitudinal planner 23 determines a computed distance Dmax (see FIG. 3) as follows:

Dmax=Dobs−Ds, where Ds is a safety distance of a few meters around the obstacle Obs.

Next, the longitudinal planner 23 determines a variable Ytr (see FIG. 3) such that:

Ytr=Wobs−Dmax/tan(ψ) where Wobs is the dimension of the obstacle orthogonally to the axis OX and therefore to the initial path of the vehicle 2, and tan(ψ) is the tangent of the yaw angle ψ of the vehicle measured by the module 27 for estimating the lateral state of the vehicle 2, this yaw angle ψ being representative of the change in direction of the vehicle 2 with respect to the axis (OX) of the fixed orthonormal frame (O, X, Y), and therefore with respect to its initial path.

If the variable Ytr has a negative value, this means that the immediate direction of the vehicle 2 toward its new path Tr is such that the vehicle 2 should not encounter the obstacle Obs. If in contrast the variable Ytr has a strictly positive value, it is because the immediate direction of the vehicle 2 toward its new path Tr is such that the vehicle 2 will encounter the obstacle Obs if it maintains this direction. In FIG. 3, the critical point Pc corresponds to the value of zero of the variable Ytr and therefore to the target point that the longitudinal axis (Gx) of the vehicle 2 must strive to reach when turning toward its new path Tr.

The longitudinal planner 23 then modifies the value of the computed distance Dmax depending on the variable Ytr and on a driving mode, selected for example by a user of the vehicle 2.

In a sporty first driving mode, when the variable Ytr has a strictly positive value, the longitudinal planner 23 increases the computed distance Dmax depending on the yaw angle ψ of the vehicle, and more precisely in a manner inversely proportional to the cosine of this measured yaw angle ψ:

Dmax=Dmax/cos(ψ)

In other words, the computed distance Dmax is set equal not to the actual distance Dobs to the obstacle Obs but to a distance of travel of the vehicle to the obstacle Obs at constant vehicle direction, this direction having the yaw angle ψ measured at a processing time by the longitudinal planner 23, a safety distance (Ds/cos(ψ)) being subtracted from this distance of travel.

When in contrast the variable Ytr has a negative value, in this sporty first driving mode, the longitudinal planner 23 gives the computed distance Dmax a very large value, for example one hundred meters, so as to no longer require the vehicle 2 to brake:

Dmax=100.

Since the distance Dobs to the obstacle is updated in real time, the computed distance Dmax is also, before modification by the longitudinal planner 23 depending on the variable Ytr. Since the computed distance Dmax is used to determine the setpoint longitudinal speed Vox, the smaller this computed distance Dmax, the more the setpoint longitudinal speed Vox causes the vehicle 2 to brake. In this sporty first driving mode, the modifications of the planner 23 let the vehicle 2 brake until the vehicle 2 is being steered so as to avoid the obstacle Obs, and then when the target point Pc has been reached by the longitudinal axis (Gx) of the vehicle 2, the latter is no longer forced to brake by the obstacle Obs, but may be forced to brake by other path constraints.

According to a smooth second driving mode, three distinct zones through which the vehicle 2 moves during its obstacle-avoidance maneuver are distinguished between. A first zone z1 extends parallel to the initial path of the vehicle 2, in the fixed orthonormal frame (O, X, Y), between an initial position of the vehicle 2 and the obstacle Obs. A second zone z2 extends parallel to the initial path of the vehicle 2, in the fixed orthonormal frame (O, X, Y), over the entire dimension Lobs of the obstacle Obs parallel to the axis (OX), i.e. between a first end of the obstacle Obs located on a straight line orthogonal to the initial path of the vehicle 2, closest to the vehicle 2, and a second end of the obstacle Obs located on a straight line orthogonal to the initial path of the vehicle 2, furthest from the vehicle 2. A third zone z3 extends parallel to the initial path of the vehicle 2, in the fixed orthonormal frame (O, X, Y), from the second end of the obstacle Obs.

In this smooth second driving mode, when the variable Ytr has a strictly positive value, the longitudinal planner 23 also increases the computed distance Dmax depending on the yaw angle ψ of the vehicle, in a manner inversely proportional to the cosine of this measured yaw angle ψ:

Dmax=Dmax/cos(ψ)

When in contrast the variable Ytr has a negative value, in this smooth second driving mode, as long as the vehicle is located in the zone z1, the longitudinal planner 23 gives the computed distance Dmax a value that no longer depends on the measured distance Dobs to the obstacle, but that rather depends on the measured yaw angle ψ and on a distance Ycg between the vehicle and the new path Tr of the vehicle 2, which is a target path:

$$D max = Y c g / sin ( ψ )$$

It will be noted that the target path Tr is parallel to the initial path of the vehicle but offset laterally with respect to this initial path.

Since Dmax is set equal to the distance Ycg between the vehicle 2 and the new path Tr of the vehicle 2, divided by the sine of the measured yaw angle ψ, this means that once the vehicle 2 has been steered so as to avoid the obstacle Obs, the braking of the vehicle 2 is dependent on the distance of travel of the vehicle 2 to the new path Tr at constant vehicle direction, this direction having the yaw angle ψ measured at the time of processing by the longitudinal planner 23. In other words, the vehicle 2 continues to brake in the zone z1 after having been steered so as to avoid the obstacle Obs, so that it may steer more smoothly than in the first driving mode toward its new path Tr.

According to a third driving mode delivering an experience that feels safer to a user, when the variable Ytr has a strictly positive value, the computed distance Dmax is always set equal, by the longitudinal planner 23, to:

$$D max = D max / cos ( ψ )$$

When in contrast the variable Ytr has a negative value, in this third driving mode, as long as the vehicle is located in the zones z1 and z2, the longitudinal planner 23 gives the computed distance Dmax a value that no longer depends on the measured distance Dobs to the obstacle, but that rather depends on the measured yaw angle ψ and on the distance Ycg between the vehicle and the new path Tr of the vehicle 2:

$$D max = Ycg / sin ( ψ )$$

In other words, as in the second driving mode, in this third mode, once the vehicle 2 has been steered so as to avoid the obstacle Obs, the braking of the vehicle 2 is dependent on the distance of travel of the vehicle 2 to the new path Tr at constant vehicle direction, this direction having the yaw angle ψ measured at the time of processing by the longitudinal planner 23. Thus, the vehicle 2 continues to brake until it bypasses the obstacle Obs, in its maneuver redirecting it to the new path Tr, this making it possible to deliver an experience that feels safer than is the case with the second driving mode.

The computed distance Dmax modified by the longitudinal planner 23 is used by the latter in a substep of optimizing an objective function J that delivers as output the setpoint longitudinal acceleration (or deceleration) ax_cons of the vehicle, integration of which provides the setpoint longitudinal velocity Vox. It is therefore a question of predictive control of the longitudinal speed of the vehicle, subject to given constraints. Naturally:

$${\dot{v}}_{x} = {a}_{x} and \dot{d} = {v}_{x}$$

where aₓ is the instantaneous longitudinal acceleration of the vehicle 2, along the longitudinal axis (Gx) of the vehicle 2, νₓ is the instantaneous longitudinal speed of the vehicle 2, along the longitudinal axis (Gx) of the vehicle 2, and d is the distance travelled by the vehicle 2 from an initial position of the vehicle 2, for example set when the vehicle 2 is on its initial path. These data are discretized into computation increments and denoted aₓ(k), νₓ(k) and d(k) to designate their value in any given computation increment k.

The predictive control consists in finding, in each computation increment k, the longitudinal acceleration aₓ(k) that minimizes the objective function J:

$$J = {\sum }_{i = 1}^{N} ( {( {v}_{x} ( k + i ) - {v}_{x , r e f} )}^{2} + {{a}_{x} ( k )}^{2} )$$

with the constraints: ∀i=1, . . . , N

$$d ( k + i ) \leq D max$$

$${a}_{x} ( k + i ) \leq {a}_{x , max}$$

$$\vert {a}_{x} ( k + i ) - {a}_{x} ( k ) \vert \leq {D}_{a}$$

where:
a_{x,max} is a maximum acceleration value not to be exceeded,
ν_{x,ref} is a reference longitudinal speed of the vehicle 2 corresponding to the projection of the reference speed \vec{V}ᵣ provided by the navigating module 22 onto the longitudinal axis (Gx) of the vehicle 2, and
Dₐ is a maximum acceleration increment or decrement between a computation increment k+i and the computation increment k.

The number N of computation increments considered by the objective function J is set by a person skilled in the art, for example following various trials of operation of the longitudinal planner 23 on a given braking system or powertrain.

The longitudinal acceleration aₓ(k) minimizing the objective function J is then taken as the setpoint longitudinal acceleration (or deceleration) ax_cons of the vehicle 2, and allows, through integration of this setpoint, the setpoint longitudinal speed Vox to be determined. This setpoint longitudinal speed Vox is then input into the lateral planner 28.

In step 12 of controlling the steering angle of the wheels of the vehicle, the lateral planner 28 uses a loop to control the steering angle δ of the wheels depending on a yaw-rate setpoint \dot{ψ}o that is a virtual reference determined in real time by solving an optimization problem, the latter for example being minimization of the quadratic distance between a previous yaw rate and a yaw rate making it possible to reach the new path Tr, depending on constraints, which in particular are related to the steering system of the vehicle 2.

The paper entitled “A Reference Governor approach for Lateral Control of Autonomous Vehicles” by Dimitrios Kapsalis et al, presented in September 2021 at the IEEE conference ITSC2021 (IEEE being the acronym of Institute of Electrical and Electronics Engineers and ITSC being the acronym of International Conference on Intelligent Transportation Systems) describes a similar control step, which uses a measured longitudinal speed of the vehicle 2.

In this embodiment of the invention, the step 12 of controlling the steering angle of the wheels uses the method described in the above document, but instead of using the measured longitudinal speed in the lateral control loop, the setpoint longitudinal speed Vox is used. Thus, the yaw-rate setpoint \dot{ψ}o takes into account the longitudinal approach strategy of the vehicle 2 implemented by the longitudinal planner 23, this making the control method 1 according to the invention more efficient.

To illustrate this improvement with respect to the prior art, tests have been carried out on the one hand with an autonomous vehicle not implementing the control method 1 according to the invention, and on the other hand with the vehicle 2 implementing the control method 1 according to the invention. During these tests, the vehicles performed an obstacle-avoidance maneuver under the same initial conditions. Each autonomous vehicle apprehends at 14 m/s (meters per second) an obstacle positioned at 17 meters therefrom, the obstacle being laterally 3.2 meters from a new lane to which it must move to avoid the obstacle. The new lane corresponds to a new path or target path T. The minimum safety distance is set to 3.2 meters in front of the obstacle.

FIG. 4 shows the path 3(t) taken by the autonomous vehicle not implementing the control method 1 according to the invention, and FIG. 5 shows the reference yaw rate \dot{ψ}ᵣ₃ derived from a reference yaw angle provided by a navigating module of this autonomous vehicle, the measured yaw rate \dot{ψ}₃ of this autonomous vehicle, and the yaw-rate setpoint \dot{ψ}ₒ₃ given to the steering system of this autonomous vehicle.

These data show that the navigating module of the autonomous vehicle gives a reference yaw angle that the autonomous vehicle is unable to follow (the measured yaw rate \dot{ψ}₃ does not follow the reference yaw rate \dot{ψ}ᵣ₃), because the request made by the navigating module exceeds the limitations of the capabilities of the steering system of the autonomous vehicle. This is due to the fact that the longitudinal speed of the vehicle is very high and influences the reference yaw rate so that it changes too quickly to be followed by the steering system of the autonomous vehicle. This is why the autonomous vehicle oscillates around its target path T and exhibits instability.

In the case of the vehicle 2 implementing the control method 1 according to the invention, various driving modes were tested. Thus, FIG. 6 shows the path 2_1(t) followed by the vehicle 2 during the obstacle-avoidance maneuver when the sporty first driving mode was selected, the path 2_2(t) followed by the vehicle 2 during the obstacle-avoidance maneuver when the smooth second driving mode was selected, and the path 2_3(t) followed by the vehicle 2 during the obstacle-avoidance maneuver when the third safer-feeling driving mode was selected.

Likewise, FIGS. 7, 8 and 9 show the longitudinal speed vx_1(t), the steering angle of the wheels δ_1(t) and the lateral acceleration ay_1(t) of the vehicle 2 during the obstacle-avoidance maneuver when the first sporty driving mode was selected, the longitudinal speed vx_2(t), the steering angle of the wheels δ_2(t) and the lateral acceleration ay_2(t) of the vehicle 2 during the obstacle-avoidance maneuver when the smooth second driving mode was selected, and the longitudinal speed vx_3(t), the steering angle of the wheels δ_3(t) and the lateral acceleration ay_3(t) of the vehicle 2 during the obstacle-avoidance maneuver when the third safer-feeling driving mode was selected, respectively. The steering angles of the wheels are expressed in degrees in FIG. 8.

These data show that when the setpoint longitudinal speed Vox is used by the lateral planner 28, in particular to determine the yaw-rate setpoint \dot{ψ}o, the vehicle 2 reaches the target path T without oscillating and without instability. This is due to the fact that the speed of the vehicle 2 is reduced before the obstacle, this allowing the lateral planner 28 to generate a yaw-rate setpoint \dot{ψ}o that stays within the physical limitations of the steering system of the vehicle 2. Specifically, from the first second the longitudinal speed and lateral acceleration of the vehicle are reduced. These figures also show that the first driving mode corresponds to the fastest of the three maneuvers shown in FIGS. 6 to 9, and that the third driving mode corresponds to the smoothest and most comfortable of these three maneuvers.

Of course, the invention is not limited to the examples that have just been described and many modifications may be made to these examples without departing from the scope of the invention.

1-10. (canceled)

11. A method for controlling a path of a vehicle approaching an obstacle, comprising:
controlling a steering angle of wheels implementing a computation of a yaw-rate setpoint of the vehicle and a loop for controlling the steering angle of the wheels depending on the computed yaw-rate setpoint, the controlling the steering angle of the wheels using a longitudinal speed of the vehicle; and
controlling a speed of the vehicle,
wherein said longitudinal speed of the vehicle is a setpoint longitudinal speed determined in the controlling the speed of the vehicle.

12. The control method as claimed in claim 11, wherein the controlling the speed of the vehicle comprises optimizing an objective function taking into account a distance computed depending on a measured distance between the vehicle and the obstacle and depending on a yaw angle of the vehicle, the optimizing providing a setpoint longitudinal acceleration of the vehicle, integration of which provides said setpoint longitudinal speed.

13. The control method as claimed in claim 12, wherein the computed distance is dependent on a minimum safety distance between the vehicle and the obstacle to be bypassed.

14. The control method as claimed in claim 12, wherein the computed distance increases as a function of the yaw angle of the vehicle at least until the yaw angle allows the obstacle to be bypassed.

15. The control method as claimed in claim 12, wherein the optimizing meets a constraint according to which a distance travelled by the vehicle during a predetermined number of computation increments must be less than said computed distance.

16. The control method as claimed in claim 12, wherein as soon as the yaw angle allows the obstacle to be bypassed, the computed distance is updated so that the computed distance no longer depends on the measured distance between the vehicle and the obstacle, in accordance with a predefined choice of driving mode.

17. The control method as claimed in claim 16, wherein as soon as the yaw angle allows the obstacle to be bypassed, the computed distance is updated so as to no longer constrain the objective function, or to constrain the objective function depending on another obstacle on the path of the vehicle, instead of said obstacle to be bypassed.

18. The control method as claimed in claim 16, wherein an environment of the vehicle is divided orthogonally to an initial path of the vehicle, into a first zone not containing the obstacle and lying between the vehicle and a first end of the obstacle, and a second zone containing the obstacle and lying between the first end of the obstacle and a second end of the obstacle, as long as the vehicle is in the first zone, as soon as the yaw angle allows the obstacle to be bypassed, the computed distance is updated such that the computed distance no longer depends on anything but the yaw angle and a distance between the vehicle and a target path of the vehicle.

19. The control method as claimed in claim 16, wherein an environment of the vehicle is divided orthogonally to an initial path of the vehicle, into a first zone not containing the obstacle and lying between the vehicle and a first end of the obstacle, and a second zone containing the obstacle and lying between the first end of the obstacle and a second end of the obstacle, as long as the vehicle is in the first zone or the second zone, as soon as the yaw angle allows the obstacle to be bypassed, the computed distance is updated such that the computed distance no longer depends on anything but the yaw angle and a distance between the vehicle and a target path of the vehicle.

20. A non-transitory computer readable medium storing a program that, when executed by one or more computers of the vehicle, causes the computer to execute:
the control method as claimed in claim 11.
